(19) United States
(12) Patent Application Publication
(10) Pub. No.: US 2023/0345193 A1
(43) Pub. Date: Oct. 26, 2023

(54) SIGNAL PROCESSING APPARATUS FOR GENERATING VIRTUAL VIEWPOINT VIDEO IMAGE, SIGNAL PROCESSING METHOD, AND STORAGE MEDIUM

(71) Applicant: CANON KABUSHIKI KAISHA, Tokyo (JP)

(72) Inventor: MASANOBU FUNAKOSHI, Kanagawa (JP)

(21) Appl. No.: 18/298,966

(22) Filed: Apr. 11, 2023

(30) Foreign Application Priority Data
Apr. 20, 2022 (JP) 2022-069554

(51) Int. Cl. H04S 7/00

(52) U.S. Cl. CPC H04S 7/301; H04S 2400/11

(57) ABSTRACT

A signal processing apparatus acquires, in a case where a sound source is located at a first position of a virtual space, impulse responses for a plurality of directions related to sound incident at a second position different from the first position in the virtual space, corrects the acquired impulse responses for the plurality of directions, according to a position of a virtual viewpoint, and generates acoustic signals for the plurality of directions at the position of the virtual viewpoint, based on an input sound source signal and the corrected impulse responses for of the plurality of directions.

### BACKGROUND OF THE DISCLOSURE

### Field of the Disclosure

The present disclosure relates to a signal processing apparatus, a signal processing method, and a storage medium.

### Description of the Related Art

There is a system that generates an acoustic signal (hereinafter referred to as virtual viewpoint sound) in a virtual viewpoint video image. Japanese Patent Application Laid-Open No. 2003-302979 discusses a technique of generating a sound field by expressing the incident direction and delay of initial reflected sound as virtual sound source distribution data of a space.

In a real-world space, a sound field (how sound is heard) changes when a viewpoint position (a listening point) moves. Therefore, how the sound field changes according to the movement of the virtual viewpoint should be reproduced in in the virtual viewpoint sound as well.

### SUMMARY OF THE DISCLOSURE

According to an aspect of the present disclosure, a signal processing apparatus includes one or more memories storing instructions, and one or more processors executing the instructions to acquire, in a case where a sound source is located at a first position of a virtual space, impulse responses for a plurality of directions related to sound incident at a second position different from the first position in the virtual space, correct the acquired impulse responses for the plurality of directions, according to a position of a virtual viewpoint, and generate acoustic signals for the plurality of directions at the position of the virtual viewpoint, based on an input sound source signal and the corrected impulse responses for of the plurality of directions.

Further features of the present disclosure will become apparent from the following description of exemplary embodiments with reference to the attached drawings.

### BRIEF DESCRIPTION OF THE DRAWINGS

FIG. 1 is a diagram illustrating an example of a functional configuration of a signal processing apparatus according to a first exemplary embodiment.

FIG. 2 is a diagram illustrating measurement of a multidirectional impulse response.

FIG. 3 is a diagram illustrating an example of a hardware configuration of the signal processing apparatus.

FIG. 4 is a diagram illustrating an example of a data structure of virtual camera information.

FIG. 5 is a diagram illustrating an example of a data structure of listening point information.

FIG. 6 is a diagram illustrating an example of a data structure of a virtual space model.

FIGS. 7A and 7B are diagrams each illustrating an example of a data structure of multidirectional impulse response information.

FIG. 8 is a flowchart illustrating an example of acoustic generation processing in the signal processing apparatus.

FIG. 9 is a flowchart illustrating an example of multidirectional impulse response acquisition processing.

FIG. 10 is a diagram illustrating an image of arrangement of a measurement sound source, an actual sound source, a measurement point, and a listening point in a virtual space.

FIG. 11 is a flowchart illustrating an example of impulse response correction processing.

FIGS. 12A to 12C are diagrams illustrating correction of an impulse response.

FIG. 13 is a flowchart illustrating an example of impulse response convolution processing.

FIG. 14 is a diagram illustrating an example of a functional configuration of a signal processing apparatus according to a second exemplary embodiment.

### DESCRIPTION OF THE EMBODIMENTS

Exemplary embodiments of the present disclosure will be described below with reference to the drawings. The exemplary embodiments described below are not intended to limit the present disclosure, and not all of the combinations of features described in the exemplary embodiments are necessarily essential configurations. Identical or similar components are denoted by the same reference numerals in the following description.

A signal processing apparatus in each of the exemplary embodiments is intended to operate together with a virtual viewpoint video generation apparatus that generates a video image (a virtual viewpoint video image) by a virtual camera placed at any position in a virtual space where a subject and a background are placed. The signal processing apparatus in each of the present exemplary embodiments generates an acoustic signal (virtual viewpoint sound) at a virtual viewpoint, which corresponds to the virtual viewpoint video image generated by the virtual viewpoint video generation apparatus. The coordinates indicating the position of the virtual camera and the orientation of the virtual camera are externally input into the signal processing apparatus as a part of virtual camera information. In the following description, a virtual viewpoint and a listening point are the same point.

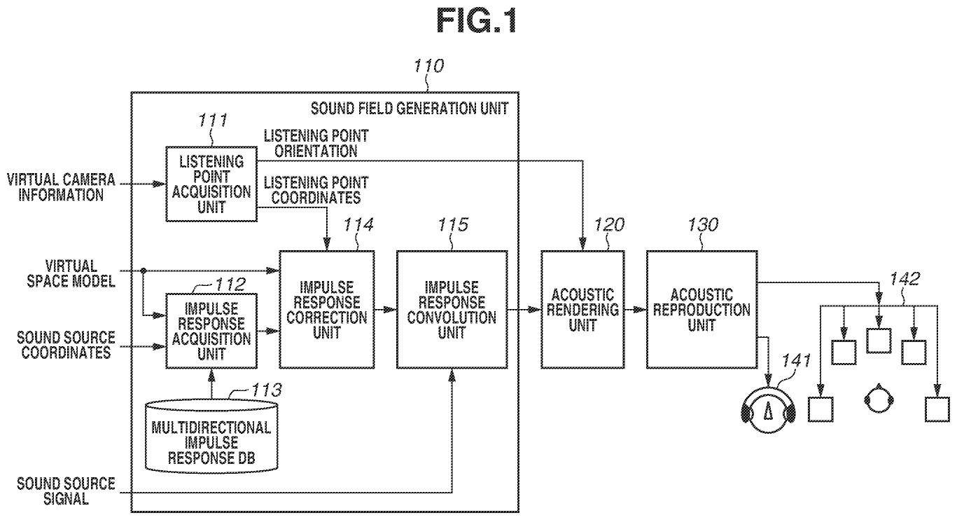

In a first exemplary embodiment, in order to simplify the description, the description will be given based on a case where the position of a sound source in a virtual space is known beforehand, and a sound source signal emitted from the sound source can be acquired. FIG. 1 is a diagram illustrating an example of a functional configuration of the signal processing apparatus in the present exemplary embodiment. The signal processing apparatus in the present exemplary embodiment includes a sound field generation unit 110, an acoustic rendering unit 120, and an acoustic reproduction unit 130.

The sound field generation unit 110 generates a sound field at a listening point (a virtual viewpoint), based on virtual camera information, a virtual space model, the coordinates of a sound source, and a sound source signal externally input. The sound field generation unit 110 includes a listening point acquisition unit 111, an impulse response acquisition unit 112, a multidirectional impulse response database (DB) 113, an impulse response correction unit 114, and an impulse response convolution unit 115.

The listening point acquisition unit 111 acquires coordinates indicating the position of the listening point (hereinafter referred to as the listening point coordinates), and a direction in which the listening point faces (hereinafter referred to as the listening point orientation), based on the virtual camera information externally input. The listening point acquisition unit 111 is an example of a virtual viewpoint acquisition unit. The listening point acquisition unit 111 acquires the listening point coordinates based on the coordinates of a virtual camera included in the virtual camera information, and acquires the listening point orientation based on the orientation of the virtual camera included in the virtual camera information. The acquired listening point coordinates are output to the impulse response correction unit 114, and the acquired listening point orientation is output to the acoustic rendering unit 120.

The impulse response acquisition unit 112 searches the multidirectional impulse response DB 113 based on the input virtual space model and sound source coordinates, acquires a multidirectional impulse response satisfying a search condition, and outputs the acquired multidirectional impulse response.

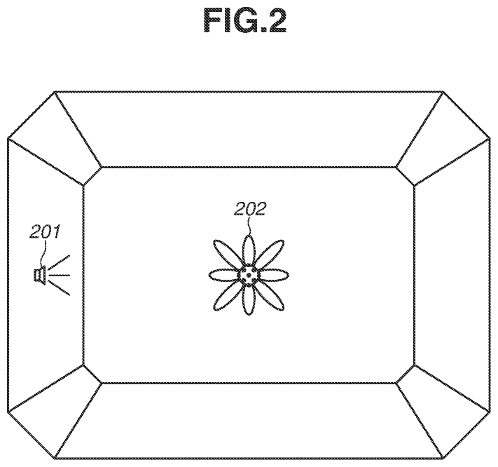

Here, the multidirectional impulse response will be described. In the present exemplary embodiment, the multidirectional impulse response is data obtained by placing a measurement sound source at one point in a virtual space, and combining impulse responses measured for a plurality of arrival directions at a measurement point, using the center of the virtual space as the measurement point. A data structure of the multidirectional impulse response will be described below. For example, as illustrated in FIG. 2, the multidirectional impulse response can be acquired by placing, in a real space corresponding to the virtual space, an omnidirectional microphone 202 including a plurality of microphone elements at the center position of the real space, and actually measuring sound from a measurement sound source 201. In other words, measurement signals such as pink noise emitted from the measurement sound source 201 are collected by the omnidirectional microphone 202, and the plurality of collected signals are subjected to signal processing, so that the impulse response of sound incident from each angle can be acquired. In a case where a plurality of sound source positions is set, a plurality of multidirectional impulse responses can be acquired by changing the position of the measurement sound source and performing measurement individually for each of the positions. Alternatively, the multidirectional impulse response can also be acquired by using a virtual space model in which a measurement sound source and a measurement point are placed, and simulating impulse responses for a plurality of directions at the measurement point in the virtual space. The center of the virtual space is used as the measurement point, but the measurement point is not limited thereto, and any point different from the point at which the measurement sound source is located may be set as the measurement point in the virtual space.

The multidirectional impulse response DB 113 stores a plurality of multidirectional impulse responses measured in various real spaces, or a plurality of multidirectional impulse responses acquired by performing acoustic simulation in a virtual space. The multidirectional impulse response DB 113 selects an appropriate multidirectional impulse response from the plurality of stored multidirectional impulse responses, based on a designated virtual space model and designated sound source coordinates, and outputs the selected multidirectional impulse response. In a case where an appropriate multidirectional impulse response corresponding to the designated virtual space model and sound source coordinates is not stored, the multidirectional impulse response DB 113 outputs a response indicating that there is no search result.

The impulse response correction unit 114 appropriately corrects the multidirectional impulse response output from the impulse response acquisition unit 112, based on the virtual space model and the listening point coordinates, and outputs the corrected multidirectional impulse response.

The impulse response convolution unit 115 convolves the input sound source signal with the impulse responses for all directions included in the multidirectional impulse response output from the impulse response correction unit 114, thereby generating acoustic signals of all directions, and outputs the generated acoustic signals.

The acoustic rendering unit 120 renders the acoustic signal of each direction generated by the impulse response convolution unit 115 into a predefined channel format such as 5.1 channel format or 22.2 channel format, and outputs the rendered acoustic signals.

The acoustic reproduction unit 130 appropriately amplifies the acoustic signals in the predefined channel format rendered by the acoustic rendering unit 120, and outputs the amplified acoustic signals to headphones 141 or a speaker array 142. The headphones 141 convert the acoustic signals rendered to two channels into sound, and outputs the sound to the ears of a listener. The speaker array 142 includes a plurality of speakers arranged based on a predefined multichannel format, converts the multichannel-rendered acoustic signals into sound, and outputs the sound toward a predetermined listening point.

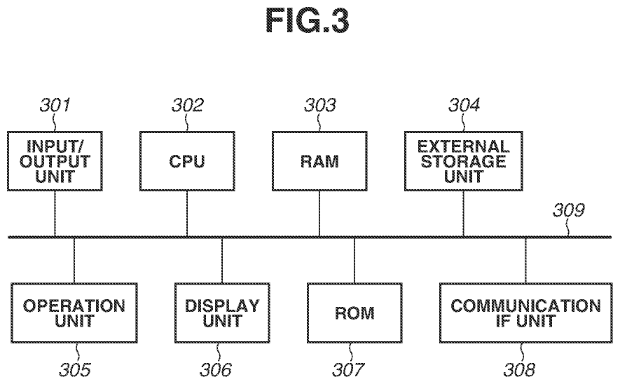

FIG. 3 is a diagram illustrating an example of a hardware configuration of the signal processing apparatus in the present exemplary embodiment. The signal processing apparatus in the present exemplary embodiment includes an input/output unit 301, a central processing unit (CPU) 302, a random access memory (RAM) 303, an external storage unit 304, an operation unit 305, a display unit 306, a read only memory (ROM) 307, a communication interface (IF) unit 308, and a bus 309. The input/output unit 301, the CPU 302, the RAM 303, the external storage unit 304, the operation unit 305, the display unit 306, the ROM 307, and the communication IF unit 308 are communicatively interconnected via the bus 309.

The input/output unit 301 accepts inputs of virtual camera information, a virtual space model, sound source coordinates, and a sound source signal from outside, and transmits the inputs to other components via the bus 309 as appropriate, based on an instruction of the CPU 302. The CPU 302 integrally controls each component of the signal processing apparatus. The CPU 302 controls other components by transmitting control signals thereto via the bus 309, and performs various calculations, based on a program. In the present exemplary embodiment, the CPU 302 executes processing according to a program stored in the ROM 307 or the external storage unit 304, thereby executing each function described with reference to FIG. 1. The RAM 303 temporarily stores a part of an active program, accompanying data, results of calculation by the CPU 302, and the like. The CPU 302 loads a necessary program and data into the RAM 303, and performs reading and writing as needed, so that the program is executed.

The external storage unit 304 stores a program body and data accumulated over a long period. For example, the external storage unit 304 implements the function of the multidirectional impulse response DB 113. Examples of the external storage unit 304 include a hard disk drive (HDD) and a solid state drive (SSD). The operation unit 305 accepts various instruction operations issued by a user, converts the accepted operations into control signals, and transmits the control signals to the CPU 302 via the bus 309. The CPU 302 controls an active program and issues instructions to control other configurations, based on the control signals. The display unit 306 displays the status of an active program and the output of the program to the user. The ROM 307 stores fixed programs including a program for starting/stopping the present hardware apparatus, and a program for controlling basic input and output, and fixed parameters. The communication IF unit 308 can input and output data to and from a communication network such as the Internet.

Various data structures in the present exemplary embodiment in such a configuration will be described.

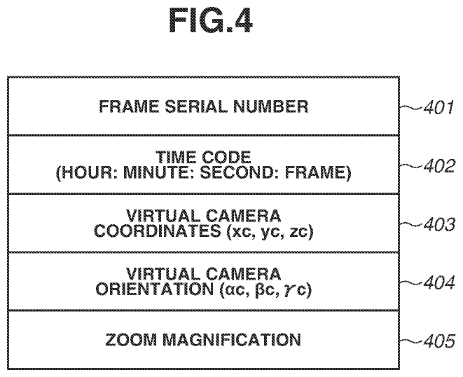

A data structure of the virtual camera information will be described with reference to FIG. 4. FIG. 4 is a diagram illustrating an example of the data structure of the virtual camera information. As illustrated in FIG. 4, the virtual camera information includes a frame serial number 401, a time code 402, virtual camera coordinates 403, a virtual camera orientation 404, and a zoom magnification 405. The frame serial number 401 is a sequential number starting from a frame at which image capturing has started, and is set to increase by one as the video image is moved forward by one frame. The frame serial number 401 is assigned to the virtual camera information on a one-to-one basis, and thus can also be used to identify an individual piece of virtual camera information. The time code 402 includes hour, minute, second, and frame, and indicates the time of the acquisition of a video signal or an acoustic signal corresponding to this virtual camera information. The same value may be added as the time code 402 to a plurality of pieces of virtual camera information, in consideration of a case where a reproduction speed for sound to be generated is changed, a case where the sound is reproduced in reverse, or a case where only the virtual camera is operated with the time code being stopped.

The virtual camera coordinates 403 are the coordinates of the virtual camera in the virtual space, and position information (xc, yc, zc) corresponding to an X-axis, a Y-axis, and a Z-axis of three-dimensional orthogonal coordinates uniquely defined by the virtual space is stored as the coordinates. The virtual camera orientation 404 is information indicating the front direction of the virtual camera, and as this information, an angle αc formed in the front direction on a YZ plane, an angle βc formed in the front direction on a ZX plane, and an angle γc formed in the front direction on an XY plane are stored. As the zoom magnification 405, a zoom magnification of the virtual camera is stored.

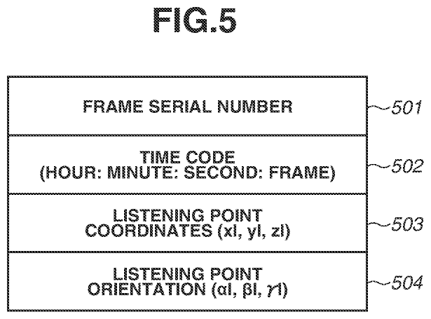

Next, a data structure of the listening point information will be described with reference to FIG. 5. FIG. 5 is a diagram illustrating an example of the data structure of the listening point information. As illustrated in FIG. 5, the listening point information includes a frame serial number 501, a time code 502, listening point coordinates 503, and a listening point orientation 504. The frame serial number 501 and the time code 502 are similar to the frame serial number 401 and the time code 402 illustrated in FIG. 4. The listening point coordinates 503 are the coordinates of the listening point in the virtual space, and position information (xl, yl, zl) corresponding to an X-axis, a Y-axis, and a Z-axis of three-dimensional orthogonal coordinates uniquely defined by the virtual space is stored as the coordinates. The listening point orientation 504 is information indicating the front direction of the listening point, and as this information, an angle αl formed in the front direction on the YZ plane, an angle βl formed in the front direction on the ZX plane, and an angle γl formed in the front direction on the XY plane are stored.

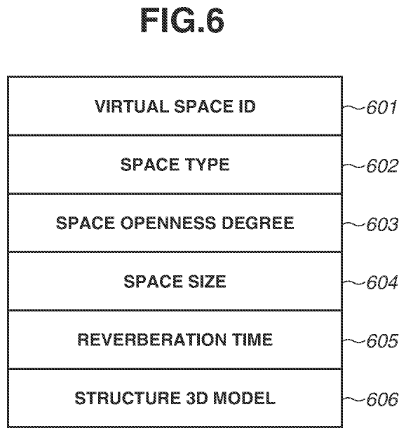

Next, a data structure of the virtual space model will be described with reference to FIG. 6. FIG. 6 is a diagram illustrating an example of the data structure of the virtual space model. As illustrated in FIG. 6, the virtual space model includes a virtual space identification (ID) 601, a space type 602, a space openness degree 603, a space size 604, a reverberation time 605, and a structure three-dimensional (3D) model 606. The virtual space ID 601 is a number assigned to distinguish this virtual space model from others, and uniquely corresponds to the virtual space model. The space type 602 is information indicating the category of the virtual space in terms of a sound field, and as this information, for example, a stadium, a concert hall, a gymnasium, a live music club, a tunnel, a room, or a free space is stored. The space type 602 is not limited thereto, and a description of, for example, a wide open space, a space fully equipped with sound facilities, a relatively wide enclosed space, an enclosed space with large sound echo, or a relatively small space may be stored as the space type 602.

The space openness degree 603 is a degree indicating how much the virtual space is open.

In the present exemplary embodiment, as an example of the space openness degree 603, in a case where the virtual space is surrounded by a rectangular solid inside which the virtual space fits, the space openness degree 603 is indicated by the number of faces of the rectangular solid having no structure in the virtual space. For example, the openness degree of a virtual space surrounded by all of the faces is 0, and the openness degree of a virtual space with the ceiling (the top surface) open and with structures present on the other faces (the four sides and the bottom face) is 1. Further, for example, the openness degree of a virtual space with a structure present only on the floor (the bottom face) and with the other faces (the four sides and the top surface) open is 5. However, the space openness degree 603 is not limited to this example.

The space size 604 is information indicating a volume occupied by this virtual space. As the space size 604, for example, the volume occupied by the virtual space is indicated in cube meters. The reverberation time 605 is a value determined by calculating an average reverberation time of sound in this virtual space, based on the multidirectional impulse response. In the present exemplary embodiment, T60 (the number of seconds before the sound attenuates by 60 dB from a maximum sound pressure) is used as an example of the reverberation time 605. However, the reverberation time 605 is not limited to this example. The structure 3D model 606 is 3D model data including walls, a floor, a ceiling, and other structures in this virtual space.

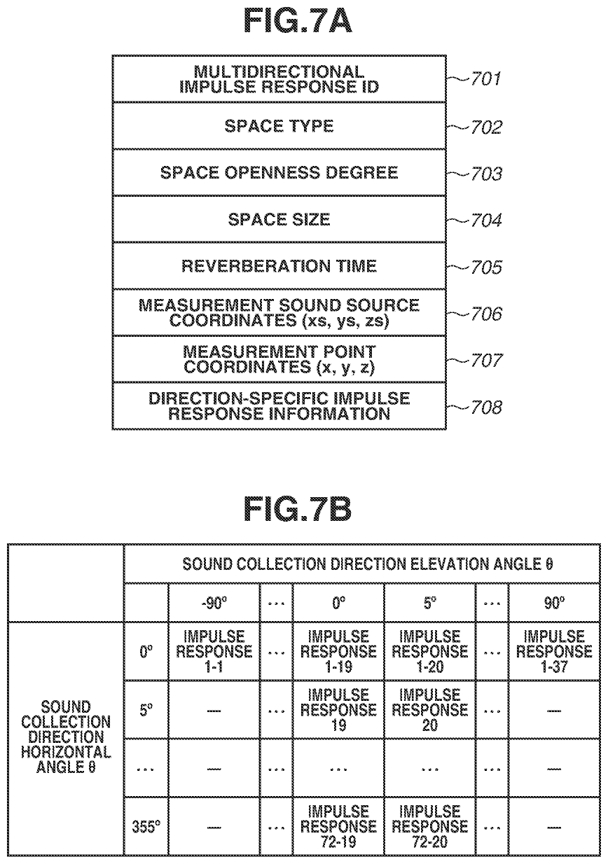

Next, a data structure of the multidirectional impulse response information will be described with reference to FIGS. 7A and 7B. FIG. 7A is a diagram illustrating an example of the data structure of the multidirectional impulse response information.

As illustrated in FIG. 7A, the multidirectional impulse response information includes a multidirectional impulse response ID 701, a space type 702, a space openness degree 703, a space size 704, a reverberation time 705, measurement sound source coordinates 706, measurement point coordinates 707, and direction-specific impulse response information 708.

The multidirectional impulse response ID 701 is a number assigned to distinguish the multidirectional impulse response from others, and uniquely corresponds to the multidirectional impulse response. The space type 702, the space openness degree 703, the space size 704, and the reverberation time 705 are pieces of information similar to the space type 602, the space openness degree 603, the space size 604, and the reverberation time 605 illustrated in FIG. 6, respectively. As each of the space type 702, the space openness degree 703, the space size 704, and the reverberation time 705, a space attribute obtained by measuring or simulating the multidirectional impulse response is stored. The measurement sound source coordinates 706 are coordinates where a measurement sound source is located to acquire this multidirectional impulse response by the measurement or simulation. The measurement point coordinates 707 are coordinates acquired by measuring or simulating the multidirectional impulse response in this space. The measurement point coordinates 707 indicate, for example, the center of the space where the multidirectional impulse response is measured.

As the direction-specific impulse response information 708, impulse response information for each direction constituting the multidirectional impulse response information is stored. FIG. 7B is a diagram illustrating an example of a data structure of the direction-specific impulse response information 708. FIG. 7B illustrates the example of the data structure of the direction-specific impulse response information 708 in a tabular format. As illustrated in FIG. 7B, a row indicates a horizontal angle of a sound collection direction, a column indicates an elevation angle of the sound collection direction, and an impulse response at the horizontal angle and the elevation angle is stored at the point where these angles intersect. An impulse response for a desired direction is obtained by searching the direction-specific impulse response information 708 based on the horizontal angle and the elevation angle of the sound collection direction at the measurement point. In a case where the elevation angle is ±90°, there are only zenith and nadir and there is no horizontal angle, and thus, in FIG. 7B, the impulse response is stored at a position where the horizontal angle is 0° for convenience. In the example illustrated in FIG. 7B, each item is set at 5° intervals for each of the horizontal angle and the elevation angle, but the interval is not limited thereto, and an interval corresponding to desirable accuracy may be adopted.

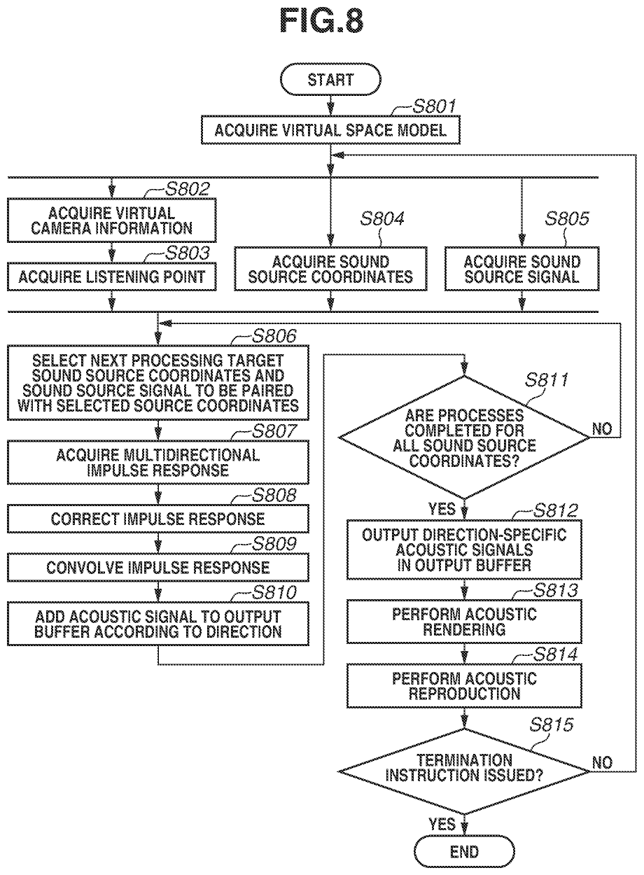

Acoustic generation processing performed by the signal processing apparatus in the present exemplary embodiment will be described. FIG. 8 is a flowchart illustrating an example of the acoustic generation processing performed by the signal processing apparatus in the present exemplary embodiment. The CPU 302 executes processing based on a program stored in the ROM 307 or the external storage unit 304, thereby executing the function of each of the sound field generation unit 110, the acoustic rendering unit 120, and the acoustic reproduction unit 130 described with reference to FIG. 1, so that each process in the flowchart is performed.

In step S801, the impulse response acquisition unit 112 and the impulse response correction unit 114 perform virtual space model acquisition processing, thereby acquiring a virtual space model as a sound generation processing target. In the virtual space model acquisition processing, the impulse response acquisition unit 112 and the impulse response correction unit 114 acquire the virtual space model transmitted from outside, via the input/output unit 301, a user operation on the operation unit 305, or the communication IF unit 308. The virtual space model acquired in step S801 is stored into the RAM 303.

Next, processes in step S802 and step S803, a process in step S804, and a process in step S805 are performed in parallel. Although the process in step S802 and step S803, the process in step S804, and the process in step S805 are performed in parallel in the present exemplary embodiment, some or all of these processes may be sequentially performed without being performed in parallel.

In step S802, the listening point acquisition unit 111 acquires virtual camera information transmitted from outside, via the input/output unit 301, a user operation on the operation unit 305, or the communication IF unit 308. The virtual camera information acquired in step S802 is stored into the RAM 303. In step S803, the listening point acquisition unit 111 acquires listening point coordinates and a listening point orientation based on the virtual camera information acquired in step S802. In the present exemplary embodiment, the coordinates and the orientation of the virtual camera are directly used as the listening point coordinates and the listening point orientation. The listening point acquisition unit 111 outputs the acquired listening point coordinates to the impulse response correction unit 114, and outputs the acquired listening point orientation to the acoustic rendering unit 120.

In step S804, the impulse response acquisition unit 112 acquires one or more sets of sound source coordinates indicating the placement positions of one or more sound sources in a virtual space and transmitted from outside, via the input/output unit 301, a user operation on the operation unit 305, or the communication IF unit 308. The sound source coordinates acquired in step S804 are stored into the RAM 303.

In step S805, the impulse response convolution unit 115 acquires one or more sound source signals transmitted from outside, via the input/output unit 301 or the communication IF unit 308. Here, the sound source signal corresponds on a one-to-one basis to the sound source coordinates acquired in step S804, and the same number of sound source signals as the number of sets of sound source coordinates acquired in step S804 are acquired in step S805. The sound source signals acquired in step S805 are stored into the external storage unit 304.

In step S806, the impulse response acquisition unit 112 selects the next sound source coordinates to be a processing target in the subsequent processing, from the one or more sets of sound source coordinates acquired in step S804. In addition, in step S806, the impulse response convolution unit 115 selects the sound source signal to be paired with the sound source coordinates selected by the impulse response acquisition unit 112, from the sound source signals acquired in step S805.

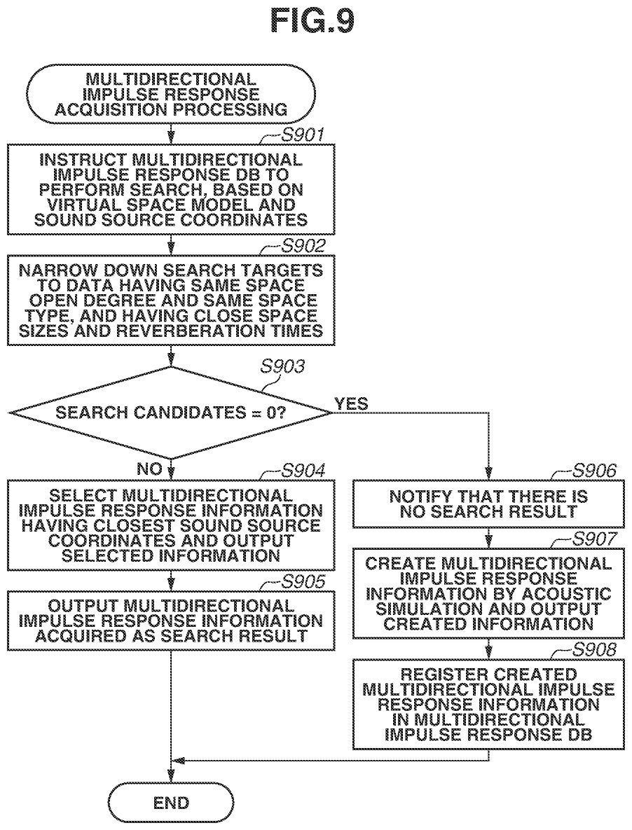

In step S807, the impulse response acquisition unit 112 performs multidirectional impulse response acquisition processing, based on the virtual space model acquired in step S801 and the sound source coordinates selected in step S806. In the multidirectional impulse response acquisition processing, based on the virtual space model and the sound source coordinates, the impulse response acquisition unit 112 acquires multidirectional impulse response information appropriate thereto, from the multidirectional impulse response DB 113. The multidirectional impulse response information acquired by the processing in step S807 is output to the impulse response correction unit 114. The details of this multidirectional impulse response acquisition processing will be described below with reference to FIG. 9.

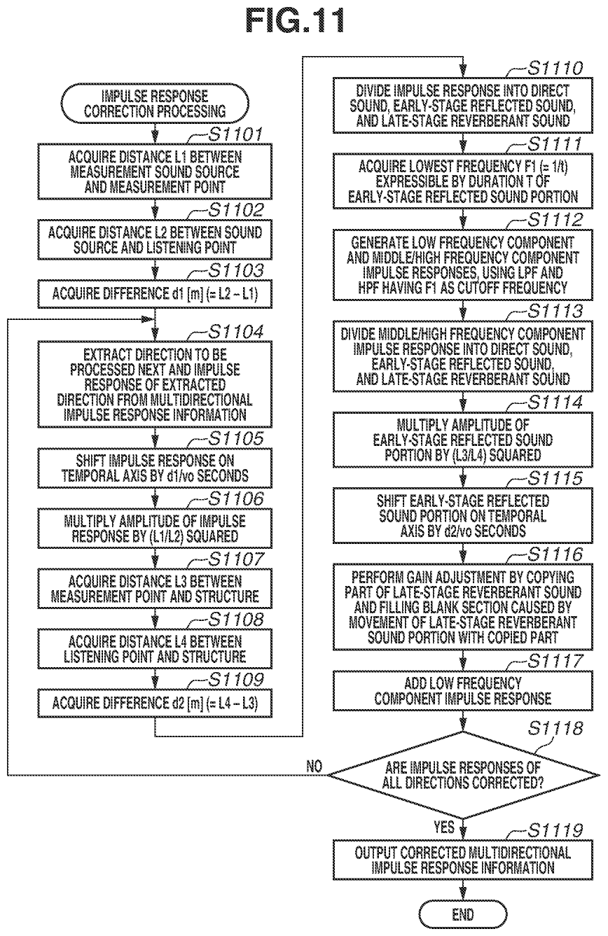

In step S808, the impulse response correction unit 114 performs impulse response correction processing, thereby correcting all the impulse responses included in the multidirectional impulse response information acquired in step S807, according to the listening point coordinates acquired in step S803. In other words, the impulse response correction unit 114 corrects the impulse responses for all directions included in the multidirectional impulse response information acquired in step S807, according to the position of the virtual viewpoint. The multidirectional impulse response information corrected by the processing in step S808 is output to the impulse response convolution unit 115. The details of this impulse response correction processing will be described below with reference to FIG. 11.

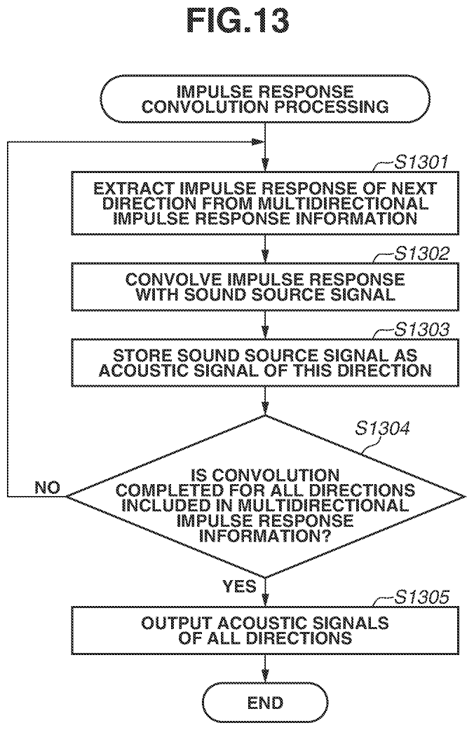

In step S809, the impulse response convolution unit 115 performs impulse response convolution processing based on the sound source signal selected in step S806 and the multidirectional impulse response information corrected in step S808. In the impulse response convolution processing, the impulse response convolution unit 115 generates a direction-specific acoustic signal at the listening point, by individually convolving all the corrected impulse responses included in the multidirectional impulse response information with the selected sound source signal. The details of this impulse response convolution processing will be described below with reference to FIG. 13.

In step S810, the impulse response convolution unit 115 adds the acoustic signal generated in step S809, to an output buffer in the impulse response convolution unit 115, according to the direction.

In step S811, the sound field generation unit 110 determines whether the processes in step S806 to step S810 are completed for all the sets of sound source coordinates acquired in step S804. In a case where the sound field generation unit 110 determines that the processes in step S806 to step S810 are not completed for all the sets of sound source coordinates, i.e., there are sound source coordinates that have not been processed (NO in step S811), the processing returns to step S806. Subsequently, in step S806, the impulse response acquisition unit 112 selects the next sound source coordinates and an acoustic signal paired with the selected sound source coordinates, and performs the series of processes in step S806 to step S810.

On the other hand, in a case where the sound field generation unit 110 determines that the processes in step S806 to step S810 are completed for all the sets of sound source coordinates (YES in step S811), a process in step 5812 is executed.

In step S812, the impulse response convolution unit 115 outputs the direction-specific acoustic signals stored in the output buffer in the impulse response convolution unit 115, to the acoustic rendering unit 120. The output acoustic signals will be collectively referred to as a multidirectional acoustic signal. The impulse response convolution unit 115 outputs all the acoustic signals and then clears the output buffer.

In step S813, the acoustic rendering unit 120 renders the multidirectional acoustic signal output in step S812 in consideration of the listening point orientation, based on a predefined three-dimensional arrangement acoustic output channel format such as 5.1.4 channel format or 22.2 channel format. The acoustic rendering unit 120, for example, divides the acoustic signal into three output channels near each direction and performs the rendering processing, using the Vector Based Amplitude Panning (VBAP) method, according to each direction of the multidirectional acoustic signal. Such processing is a known process which is commonly performed in the field of multichannel sound reproduction, and thus the description thereof will be omitted. The acoustic signal rendered in the predefined channel format is output to the acoustic reproduction unit 130.

In step S814, the acoustic reproduction unit 130 appropriately amplifies the acoustic signal rendered in the predefined channel format in step S813, and outputs the amplified acoustic signal to the headphones 141 or the speaker array 142. The acoustic signal is thereby converted into sound, and the sound is output as stereophonic sound.

In step S815, the signal processing apparatus determines whether an instruction to terminate the processing is issued by a user operation on the operation unit 305. In a case where the signal processing apparatus determines that the termination instruction is not issued (NO in step S815), the processing returns to step S802, step S804, and step S805 to continue the acoustic generation processing. In a case where the signal processing apparatus determines that the termination instruction is issued (YES in step S815), the acoustic generation processing ends.

FIG. 9 is a flowchart illustrating an example of the multidirectional impulse response acquisition processing in step S807 in FIG. 8. The impulse response acquisition unit 112 and the multidirectional impulse response DB 113 execute processes in the multidirectional impulse response acquisition processing illustrated in FIG. 9.

In step S901, the impulse response acquisition unit 112 instructs the multidirectional impulse response DB 113 to search for the multidirectional impulse response information, based on the virtual space model acquired in step S801 and the sound source coordinates selected in step S806.

In step S902, the multidirectional impulse response DB 113 narrows down search targets in the stored multidirectional impulse response information. The multidirectional impulse response DB 113 narrows down the search targets to data having the same space openness degree and space type and close space size and reverberation time included in the virtual space model of the instruction provided in step S901, among the pieces of stored multidirectional impulse response information. In the present exemplary embodiment, for example, data in a range of around 10% of the original value for each of the designated space size and reverberation time is determined as the close data. This range is merely an example, and the range to be used is not limited thereto, and can be determined in a scope not departing from the gist of the present disclosure.

In step S903, the multidirectional impulse response DB 113 determines whether the number of search candidates for the multidirectional impulse response information narrowed down in step S902 is 0. In a case where the multidirectional impulse response DB 113 determines that the number of search candidates is not 0 (NO in step S903), a process in step S904 is executed. On the other hand, in a case where the multidirectional impulse response DB 113 determines that the number of search candidates is 0 (YES in step S903), a process in step S906 is executed.

In step S904, the multidirectional impulse response DB 113 selects multidirectional impulse response information having measurement sound source coordinates closest to the sound source coordinates designated in step S901, as a search result, from the narrowed-down search candidates. The multidirectional impulse response DB 113 outputs the selected multidirectional impulse response information to the impulse response acquisition unit 112.

In step S905, the impulse response acquisition unit 112 outputs the multidirectional impulse response information acquired as the search result in step S904 and the sound source coordinates, to the impulse response correction unit 114. Upon termination of the process in step S905, the multidirectional impulse response acquisition processing ends, and the processing returns to the acoustic generation processing illustrated in FIG. 8.

In step S906, the multidirectional impulse response DB 113 notifies the impulse response acquisition unit 112 that there is no search result (the number of search candidates is 0).

In step S907, upon being notified that there is no search result from the multidirectional impulse response DB 113, the impulse response acquisition unit 112 performs acoustic simulation, using the virtual space model acquired in step S801 and the sound source coordinates selected in step S806. For example, the impulse response acquisition unit 112 thereby calculates the impulse responses of all direction constituting the multidirectional impulse response information at the center position of the virtual space model. In the present exemplary embodiment, this acoustic simulation is performed by calculation using a technique such as a sound ray tracing method, a finite element method (FEM), or a boundary element method (BEM). Such acoustic simulation is a known technique which is commonly performed in various fields such as architectural acoustics, and thus will not be described in detail here. The impulse response acquisition unit 112 creates new multidirectional impulse response information using the sound source coordinates as the measurement sound source coordinates, in addition to the multidirectional impulse response obtained by the calculation. In this way, the impulse response acquisition unit 112 creates the multidirectional impulse response information by the acoustic simulation, and outputs the created multidirectional impulse response information to the impulse response correction unit 114, together with the sound source coordinates.

The impulse response acquisition unit 112 may perform the above-described acoustic simulation before the processing in this flowchart starts. In this case, the result of the acoustic simulation is recorded in the RAM 303 or the ROM 307. Further, in this case, the impulse response acquisition unit 112 performs processing of acquiring the result of the acoustic simulation in step S907.

In step S908, the impulse response acquisition unit 112 registers the multidirectional impulse response information created in step S907, in the multidirectional impulse response DB 113. As a result, in a case where a virtual space model having various attributes close to those of the virtual space model designated this time is subsequently input, the multidirectional impulse response information can be acquired only by searching the multidirectional impulse response DB 113 without performing the acoustic simulation or the like. Upon termination of the process in step S908, the multidirectional impulse response acquisition processing ends, and the processing returns to the acoustic generation processing illustrated in FIG. 8.

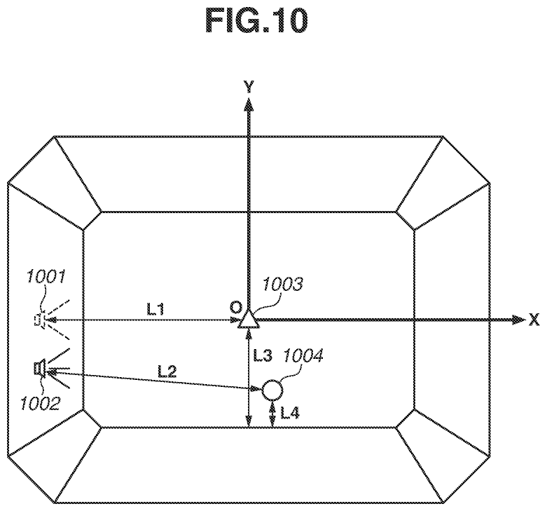

Next, the impulse response correction processing in step S808 in FIG. 8 will be described. Here, to make the description of the impulse response correction processing easy to understand, how the measurement sound source and the measurement point of the multidirectional impulse response, and the sound source coordinates and the listening point input from outside, are specifically arranged in the virtual space model in the present exemplary embodiment will be described with reference to FIG. 10.

FIG. 10 is a schematic diagram illustrating an image of arrangement of the measurement sound source, the sound source, the measurement point, and the listening point in the virtual space model. FIG. 10 illustrates an example in which the space type of the virtual space model is a stadium. For the world coordinates of this virtual model, the center of the stadium is the origin, an X-axis is a long-side direction (the right side in FIG. 10 is a positive direction), and a Y-axis is a short-side direction (the upper side in FIG. 10 is a positive direction). A plane formed by the X-axis and the Y-axis is a horizontal plane, and a Z-axis (not illustrated) is orthogonal to the horizontal plane at the origin. For the direction of the horizontal plane, the positive direction of the Y-axis is 0°, and an angle in a counterclockwise direction is a positive angle.

In FIG. 10, a measurement sound source 1001 indicates the position of the sound source placed when the multidirectional impulse response is measured or simulated. A sound source 1002 indicates the designated sound source coordinates transmitted from outside to the signal processing apparatus. A measurement point 1003 indicates the coordinates at which the multidirectional impulse response is measured or simulated. A listening point 1004 indicates the listening point. Further, a distance L1 is the distance between the measurement sound source 1001 and the measurement point 1003, and a distance L2 is the distance between the sound source 1002 and the listening point 1004. A distance L3 is the distance between a structure (in this example, a stand) in the direction of a horizontal plane of 180° and the measurement point 1003, and a distance L4 is the distance between the structure in the direction of the horizontal plane of 180° and the listening point 1004. In this example, the position of the measurement sound source 1001 corresponds to a first position, the position of the measurement point 1003 corresponds to a second position, and the position of the listening point 1004 corresponds to the position of the virtual viewpoint.

FIG. 11 is a flowchart illustrating an example of the impulse response correction processing in step S808 in FIG. 8. The impulse response correction unit 114 executes all processes in the impulse response correction processing illustrated in FIG. 11.

In step S1101, the impulse response correction unit 114 acquires the distance L1 between the measurement sound source and the measurement point, based on the measurement sound source coordinates and the measurement point coordinates included in the multidirectional impulse response information acquired from the impulse response acquisition unit 112. In step S1102, the impulse response correction unit 114 acquires the distance L2 between the sound source and the listening point, based on the sound source coordinates acquired from the impulse response acquisition unit 112 and the listening point coordinates acquired from the listening point acquisition unit 111. The process in step S1101 may be performed after the process in step S1102, or the process in step S1101 and the process in step S1102 may be performed in parallel. Next, in step S1103, the impulse response correction unit 114 acquires a difference d1 (=L2−L1) between the distance L1 between the measurement sound source and the measurement point, and the distance L2 between the sound source and the listening point.

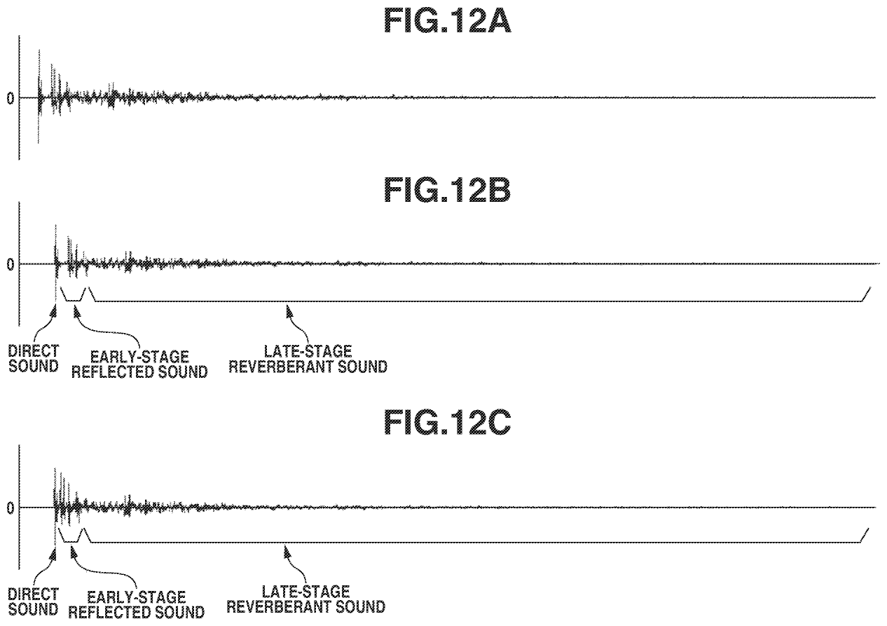

In step S1104, the impulse response correction unit 114 extracts a direction to be processed next and an impulse response for this direction, from the multidirectional impulse response information acquired from the impulse response acquisition unit 112. The direction and the impulse response extracted from the multidirectional impulse response information are stored in a predetermined region on the RAM 303. The impulse response processed in each of the subsequent steps is also stored in the predetermined region on the RAM 303. Here, FIGS. 12A to 12C illustrate an example of the impulse response. FIGS. 12A to 12C are diagrams illustrating correction of the impulse response in the present exemplary embodiment. FIG. 12A illustrates the impulse response extracted from the multidirectional impulse response information, and the impulse response correction unit 114 corrects this impulse response according to the position of the listening point.

In step S1105, the impulse response correction unit 114 acquires a delay time corresponding to the difference in distance between the sound sources, by dividing the difference d1 in distance between the sound sources acquired in step S1103 by a sound velocity vo. Subsequently, the impulse response correction unit 114 performs processing of shifting the impulse response extracted in step S1104 by the delay time on a temporal axis. Here, the impulse response starts with direct sound, and phenomena that occur thereafter all result from the direct sound, and thus all components in the impulse response shift if the time of the direct sound shifts. The time of arrival of the direct sound does not depend on the incident direction, and thus the same processing is performed here on the impulse response for any direction.

In step S1106, based on the distance L1 between the measurement sound source and the measurement point and the distance L2 between the sound source and the listening point, the impulse response correction unit 114 multiplies the overall amplitude of the impulse response by the square of (L1/L2). The impulse response correction unit 114 thereby corrects the impulse response based on a distance attenuation caused by a change in the distance from the sound source. In this way, the impulse response correction unit 114 performs correction on the delay and the amplitude of the impulse response by the process in step S1105 and the process in step S1106, and reflects the influence of the difference in the distance to the sound source that occurs depending on the position of the listening point, on the impulse response. FIG. 12B illustrates the result of the correction performed in step S1105 and step S1106 on the impulse response illustrated in FIG. 12A, in a case where the position of the listening point is located at the position illustrated in FIG. 10. In this example, the distance from the sound source is longer than at the time of the measurement of the impulse response (L2>L1), and thus the amplitude is reduced by adding the delay to the impulse response illustrated in FIG. 12A.

In step S1107, the impulse response correction unit 114 acquires the distance L3 to a structure present in the direction extracted in step S1104 when viewed from the measurement point, using the information about the virtual space model. Here, the structure is a structure having a size that can cause sound to reflect, and present in the incident direction (the direction extracted in step S1104) of the impulse response. For example, in the virtual space model illustrated in FIG. 10, a case where the extracted direction is the horizontal plane of 180° is illustrated. In this virtual space model, the stand is present as the structure in the direction of the horizontal plane of 180° from the measurement point 1003, and thus the impulse response correction unit 114 calculates a distance from the measurement point 1003 to the stand in the direction of the horizontal plane of 180°, as the distance L3. In step S1108, the impulse response correction unit 114 acquires the distance L4 to the structure present in the direction extracted in step S1104 when viewed from the listening point, using the information about the virtual space model. For example, in the virtual space model illustrated in FIG. 10, the stand is present as the structure in the direction of the horizontal plane of 180° from the listening point 1004, and thus the impulse response correction unit 114 calculates a distance from the listening point 1004 to the stand in the direction of the horizontal plane of 180°, as the distance L4. The process in step S1107 may be performed after the process in step S1108, or the process in step S1107 and the process in step S1108 may be performed in parallel. Next, in step S1109, the impulse response correction unit 114 acquires a difference d2 (=L4−L3) between the distance L3 between the measurement point and the structure, and the distance L4 between the listening point and the structure.

In step S1110, the impulse response correction unit 114 divides the impulse response corrected in step S1106 into three regions on the temporal axis, which are direct sound, early-stage reflected sound, and late-stage reverberant sound. For example, the impulse response correction unit 114 divides the impulse response into the three regions of the direct sound, the early-stage reflected sound, and the late-stage reverberant sound, based on the distance to the structure, the magnitude of the amplitude, and the like.

In step S1111, the impulse response correction unit 114 acquires a lowest frequency f1 (=1/t) that is able to be expressed by a duration t of the early-stage reflected sound portion obtained the division in step S1110. For example, in a case where the duration of the early-stage reflected sound portion is 0.02 seconds, the lowest frequency f1 is 50 (=1/0.02) Hz.

In step S1112, the impulse response correction unit 114 generates a low frequency component impulse response and a middle/high frequency component impulse response, based on the impulse response corrected in step S1106 and the lowest frequency f1 acquired in step S1111. The low frequency component impulse response is generated by the impulse response correction unit 114, by applying a low pass filter (LPF) that is designed using the lowest frequency f1 as a cutoff frequency, to the impulse response corrected in step S1106. The middle/high frequency component impulse response is generated by the impulse response correction unit 114, by applying a high pass filter (HPF) that is designed using the lowest frequency f1 as a cutoff frequency, to the impulse response corrected in step S1106.

In step S1113, the impulse response correction unit 114 divides the middle/high frequency component impulse response generated in step S1112 into direct sound, early-stage reflected sound, and late-stage reverberant sound on the temporal axis.

In step S1114, based on the distance L3 between the measurement point and the structure and the distance L4 between the listening point and the structure, the impulse response correction unit 114 multiplies the amplitude of the early-stage reflected sound portion in the middle/high frequency component impulse response obtained by the division in step S1113, by the square of (L3/L4). The impulse response correction unit 114 thereby performs correction based on the distance attenuation of the reflected sound due to the difference in distance from the structure.

In step S1115, the impulse response correction unit 114 divides the difference d2 in the distance to the structure acquired in step S1109 by the sound velocity vo, thereby acquiring a reflection delay time due to the structure in the direction according to the difference in the distance to the structure. Subsequently, the impulse response correction unit 114 shifts only the early-stage reflected sound portion in the middle/high frequency component impulse response obtained by the division in step S1113, on the temporal axis by the reflection delay time. In a case where a part of the early-stage reflected sound portion precedes the direct sound portion because of this operation, the part is deleted. In this way, the impulse response correction unit 114 performs correction on the delay and the amplitude of the early-stage reflected sound portion in the impulse response by performing the process in step S1114 and the process in step S1115, and reflects a change in reflection from the structure in the direction, which occurs at the position of the listening point, on the impulse response.

In step S1116, the impulse response correction unit 114 copies a part of the late-stage reverberant sound portion, and fills a blank section, which is caused by the movement of the late-stage reverberant sound portion in step S1115, between the early-stage reflected sound portion and the late-stage reverberant sound portion with the copied part, thereby performing gain adjustment. This prevents occurrence of an unnatural temporal section in the impulse response.

In step S1117, the impulse response correction unit 114 adds the low frequency component impulse response generated in step S1112 to the middle/high frequency component impulse response obtained in step S1116. The low frequency component of the impulse response which is corrupted by the movement of the early-stage reflected sound portion on the temporal axis can be thereby saved. Performing the processes up to this step S1117 completes the correction of the impulse response for this direction extracted in step S1104.

FIG. 12C illustrates the impulse response obtained by correcting the impulse response illustrated in FIG. 12B by the processing up to this point. The distance between the structure present in the direction of the horizontal plane of 180° and the listening point is shorter than the distance between the structure and the measurement point (L4<L3), and thus the time between the early-stage reflected sound portion and the direct sound portion is reduced, and the amplitude of the early-stage reflected sound portion is increased. In addition, the blank section caused by the movement of the early-stage reflected sound portion is filled with the copied and amplified part of the late-stage reverberant sound portion, so that the early-stage reflected sound portion and the late-stage reverberant sound portion are connected while maintaining an appropriate attenuation factor.

In step S1118, the impulse response correction unit 114 determines whether the impulse responses for all the directions included in the multidirectional impulse response information are corrected. In a case where the impulse response correction unit 114 determines that there is an impulse response for a direction not yet corrected (NO in step S1118), the processing returns to step S1104. Subsequently, in step S1104, the impulse response correction unit 114 extracts a direction to be processed next and an impulse response for this direction, and corrects the impulse response. On the other hand, in a case where the impulse response correction unit 114 determines that the impulse responses for all the directions are corrected (YES in step S1118), a process in step S1119 is executed.

In step S1119, the impulse response correction unit 114 outputs the multidirectional impulse response information corrected by the processing up to this point, to the impulse response convolution unit 115. Upon termination of the process in step S1119, the impulse response correction processing ends, and the processing returns to the acoustic generation processing illustrated in FIG. 8.

FIG. 13 is a flowchart illustrating an example of the impulse response convolution processing in step S809 in FIG. 8. The impulse response convolution unit 115 executes all processes in the impulse response convolution processing illustrated in FIG. 13.

In step S1301, the impulse response convolution unit 115 extracts an impulse response for the next direction, from the corrected multidirectional impulse response information acquired from the impulse response correction unit 114.

In step S1302, the impulse response convolution unit 115 convolves the impulse response extracted in step S1301 with the sound source signal acquired in step S805. At the listening point, a sound source signal arriving from the direction corresponding to the impulse response extracted in step S1301 is thereby generated.

In step S1303, the impulse response convolution unit 115 stores the sound source signal generated in step S1302 in a predetermined region on the RAM 303, as an acoustic signal of the direction corresponding to the impulse response extracted in step S1301.

In step S1304, the impulse response convolution unit 115 determines whether the convolution processing is completed for the impulse responses for all the directions included in the corrected multidirectional impulse response information acquired from the impulse response correction unit 114. In a case where the impulse response convolution unit 115 determines that the convolution processing is not completed for the impulse responses for all the directions, i.e., in a case where there is an impulse response for a direction for which the convolution processing has not yet been performed (NO in step S1304), the processing returns to step S1301. Subsequently, in step S1301, the impulse response convolution unit 115 extracts an impulse response for the next direction, and performs the convolution processing. On the other hand, in a case where the impulse response convolution unit 115 determines that the convolution processing is completed for the impulse responses for all the directions (YES in step S1304), a process in step S1305 is executed.

In step S1305, the impulse response convolution unit 115 outputs the acoustic signals of all the directions stored in the RAM 303 to the acoustic rendering unit 120. Upon termination of the process in step S1305, the impulse response convolution processing ends, and the processing returns to the acoustic generation processing illustrated in FIG. 8.

As described above, in the present exemplary embodiment, the position of the listening point is acquired based on the virtual camera coordinates, and the delay of the impulse response for each direction included in the multidirectional impulse response information is corrected by the distance between the listening point and the sound source. In addition, the delay of the early-stage reflected sound portion of the impulse response for each direction included in the multidirectional impulse response information is adjusted based on the positional relationship between the structure in the direction and the listening point. Moreover, the blank section of the late-stage reverberant sound portion caused by the adjustment of the early-stage reflected sound portion is filled appropriately so that the corrected impulse response becomes natural. According to the present exemplary embodiment, the multidirectional acoustic signal appropriate to the listening point coordinates can be generated by convolving each of the corrected impulse responses for the respective directions, so that a sound field suitable for the position of the listening point serving as the virtual viewpoint can be expressed.

In the present exemplary embodiment, in a case where the position of a sound source and a sound source signal from the sound source are already known, optimum sound can be reproduced based on a listening position and a listening direction of the virtual camera. In the present exemplary embodiment, the distance attenuation of the signal according to the difference in distance is expressed by the ratio to the distance, but a change in acoustic characteristics due to a temperature or a humidity may be added.

Further, in the present exemplary embodiment, the impulse response acquisition unit 112 acquires the multidirectional impulse response information from the multidirectional impulse response DB 113, and outputs the acquired multidirectional impulse response information to the impulse response correction unit 114. However, the present exemplary embodiment is not limited thereto. For example, the impulse response acquisition unit 112 may acquire the multidirectional impulse response ID of the multidirectional impulse response information, and output the acquired ID to the impulse response correction unit 114. Subsequently, the impulse response correction unit 114 may acquire the multidirectional impulse response information from the multidirectional impulse response DB 113, based on the multidirectional impulse response ID acquired from the impulse response acquisition unit 112.

In the first exemplary embodiment, the example in which the sound field is generated using the sound source signal prepared beforehand is described. In a second exemplary embodiment, an example in which a sound field is generated using sound source signals of sound collected in real time in a real space approximating to a virtual space model will be described. Description of configurations and processes similar to those in the first exemplary embodiment will be omitted.

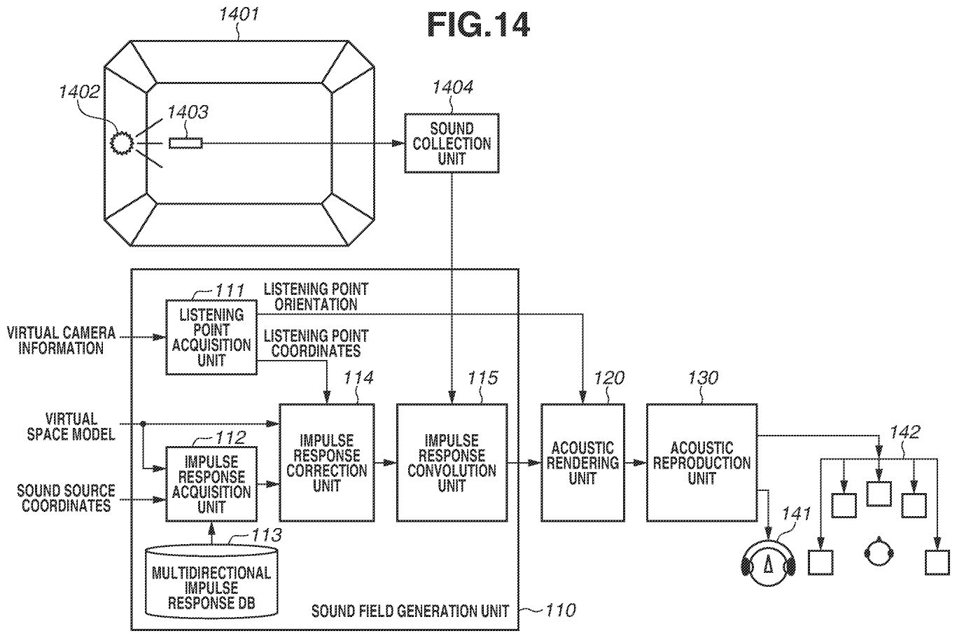

FIG. 14 is a diagram illustrating a configuration of the signal processing apparatus in the present exemplary embodiment. In FIG. 14, components having functions similar to those of the components illustrated in FIG. 1 are denoted by the same reference numerals as those in FIG. 1, and the description will not be repeated.

FIG. 14 illustrates a real space 1401 where sound is collected, and the real space 1401 imitates a stadium as an example. A sound source 1402 is an actual sound source from which sound is collected as a sound collection target, and is located near a sound source position in measuring a multidirectional impulse response. A microphone 1403 collects sound emitted from the sound source 1402 as a sound collection target, converts the collected sound into an electrical signal, and outputs the electrical signal to a sound collection unit 1404. The microphone 1403 is disposed at a position appropriate for collecting sound from the sound source 1402 and the vicinity thereof. The sound collection unit 1404 appropriately performs amplification processing, sound adjustment processing, and the like on the electrical signal output from the microphone 1403, converts the electrical signal into a digital acoustic signal, and outputs the digital acoustic signal to an impulse response convolution unit 115.

A virtual space model that is input into a sound field generation unit 110 is a virtual space model imitating the real space 1401. In addition, sound source coordinates that are input into the sound field generation unit 110 are given values obtained by converting coordinates where the sound source 1402 is located in the real space 1401 into coordinates of the virtual space model. The position of the sound source 1402 is located on an axis in the direction in which the microphone 1403 faces, and the position can be estimated.

Acoustic generation processing performed by the signal processing apparatus in the present exemplary embodiment is executed according to a flowchart similar to the flowchart illustrated in FIG. 8 in the first exemplary embodiment. However, in the second exemplary embodiment, the acoustic generation processing differs from the processing in the flowchart of FIG. 8 only in the process of acquiring the sound source signal in step S805, and sound collection processing is performed by the sound collection unit 1404 in step S805 in the second exemplary embodiment. In the sound collection processing, the sound collection unit 1404 receives an electrical signal of collected sound transmitted by the microphone 1403, appropriately performs amplification processing, sound adjustment processing, and the like, converts the signal into a digital signal, and outputs the digital signal to the impulse response convolution unit 115.

According to the present exemplary embodiment, a change in sound field according to the movement of a listening point serving as a virtual viewpoint can be expressed using sound source signals of sound collected in real time in a real space approximating to a virtual space model. In the present exemplary embodiment, even if a sound source position moves or in a case where there is a plurality of sound sources, optimum sound can be reproduced based on a listening position and a listening direction of a virtual camera.

### Other Exemplary Embodiments

In the examples described above, the coordinates and the orientation of the virtual camera indicated by the virtual camera information are directly used as the listening point coordinates and the listening point orientation, but coordinates and an orientation different from the coordinates and the orientation of the virtual camera may be set as the listening point coordinates and the listening point orientation. For example, the listening point coordinates may be set on a straight line extended in a direction of the orientation of the virtual camera from the coordinates of the virtual camera. In this case, the listening point coordinates may be calculated using the coordinates of a subject of which the size is recognizable, an angle of view occupying the video image, a zoom magnification of the virtual camera, and the like.

Further, in the exemplary embodiments described above, the function of the multidirectional impulse response DB 113 is implemented by the external storage unit 304, but may be implemented by the RAM 303 or the ROM 307. For example, a high-speed DB search can be performed if the function of the multidirectional impulse response DB 113 is implemented by the RAM 303.

Information indicating the listening point may be acquired using a virtual microphone, instead of the virtual camera. The position and the direction thereof may be individually set.

Further, a plurality of pieces of multidirectional impulse response information for a plurality of points may be acquired using a plurality of omnidirectional microphones, and the acquired information may be used. Accuracy can be further improved by using the multidirectional impulse response information for a point close to the listening point.

The present disclosure can also be implemented by processing for supplying a program for implementing one or more functions in the above-described exemplary embodiments to a system or apparatus via a network or a storage medium and causing one or more processors in a computer of the system or apparatus to read and execute the program. The present disclosure can also be implemented by a circuit (for example, an application specific integrated circuit (ASIC)) that implements the one or more functions.

Any of the above-described exemplary embodiments is merely an example for embodying the present disclosure, and the technical scope of the present disclosure is not to be interpreted by these exemplary embodiments in a limited way. In other words, the present disclosure can be implemented in various forms without departing from the technical idea or the central feature of the present disclosure. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-069554, filed Apr. 20, 2022, which is hereby incorporated by reference herein in its entirety.

What is claimed is:

1. A signal processing apparatus comprising:
one or more memories storing instructions; and
one or more processors executing the instructions to:
acquire, in a case where a sound source is located at a first position of a virtual space, impulse responses for a plurality of directions related to sound incident at a second position in the virtual space, the second position being different from the first position;
correct the acquired impulse responses for the plurality of directions, according to a position of a virtual viewpoint; and
generate acoustic signals for the plurality of directions at the position of the virtual viewpoint, based on an input sound source signal and the corrected impulse responses for of the plurality of directions.

2. The signal processing apparatus according to claim 1, wherein the one or more processors further execute the instructions to acquire the position of the virtual viewpoint, based on coordinates and an orientation of a virtual camera disposed in the virtual space.

3. The signal processing apparatus according to claim 1, wherein the one or more processors execute the instructions to acquire the impulse responses for the plurality of directions, for each sound source that emits the sound source signal.

4. The signal processing apparatus according to claim 1, wherein the one or more processors execute the instructions to convolve the sound source signal with the impulse responses for the plurality of directions corrected by the correction unit, and generate the acoustic signals for of the plurality of directions at the position of the virtual viewpoint.

5. The signal processing apparatus according to claim 1, wherein the one or more processors execute the instructions to correct a delay and an amplitude of each of the impulse responses, based on a distance between the first position and the second position, and a distance between the sound source emitting the sound source signal and the position of the virtual viewpoint.

6. The signal processing apparatus according to claim 5, wherein the one or more processors execute the instructions to divide each of the impulse responses into a direct sound portion, an early-stage reflected sound portion, and a late-stage reverberant sound portion, and correct an amplitude of the early-stage reflected sound portion and a delay of the direct sound portion in the impulse response, based on a distance between a structure in a direction of the impulse response in the virtual space and the second position, and a distance between the structure and the position of the virtual viewpoint.

7. The signal processing apparatus according to claim 6, wherein the one or more processors execute the instructions to correct, using a part of the late-stage reverberant sound portion, a blank section between the early-stage reflected sound portion and the late-stage reverberant sound portion, the blank section being caused by correcting the early-stage reflected sound portion.

8. The signal processing apparatus according to claim 6, wherein the acquired impulse responses for the plurality of directions are impulse responses obtained by measurement in a real space corresponding to the virtual space.

9. The signal processing apparatus according to claim 6, wherein the acquired impulse responses for the plurality of directions are impulse responses obtained by an acoustic simulation in the virtual space.

10. The signal processing apparatus according to claim 6, wherein the sound source signal is a signal of sound collected by a microphone that collects sound generated at a position corresponding to the first position in a real space corresponding to the virtual space.

11. The signal processing apparatus according to claim 1, wherein the one or more processors execute the instructions to divide each of the impulse responses into a direct sound portion, an early-stage reflected sound portion, and a late-stage reverberant sound portion, and correct an amplitude of the early-stage reflected sound portion and a delay for the direct sound portion in the impulse response, based on a distance between a structure in a direction of the impulse response in the virtual space and the second position, and a distance between the structure and the position of the virtual viewpoint.

12. The signal processing apparatus according to claim 11, wherein the one or more processors execute the instructions to correct, using a part of the late-stage reverberant sound portion, a blank section between the early-stage reflected sound portion and the late-stage reverberant sound portion, the blank section being caused by correcting the early-stage reflected sound portion.

13. A signal processing method comprising:
acquiring, in a case where a sound source is located at a first position of a virtual space, impulse responses for a plurality of directions related to sound incident at a second position in the virtual space, the second position being different from the first position;
correcting the acquired impulse responses for the plurality of directions, according to a position of a virtual viewpoint; and
generating acoustic signals for the plurality of directions at the position of the virtual viewpoint, based on an input sound source signal and the corrected impulse responses for the plurality of directions.

14. A non-transitory computer-readable storage medium storing a program for causing a computer to execute a signal processing method, the signal processing method comprising:
acquiring, in a case where a sound source is located at a first position of a virtual space, impulse responses for a plurality of directions related to sound incident at a second position in the virtual space, the second position being different from the first position;
correcting the acquired impulse responses for the plurality of directions, according to a position of a virtual viewpoint; and
generating acoustic signals for the plurality of directions at the position of the virtual viewpoint, based on an input sound source signal and the corrected impulse responses for the plurality of directions.
